(19) United States
(12) Patent Application Publication
(10) Pub. No.: US 2009/0030113 A1
(43) Pub. Date: Jan. 29, 2009

(54) UNIVERSAL PIGMENT PREPARATIONS

(75) Inventors: Patrick Glockner, Haltern am See (SE); Evelny Albrecht, Recklinghausen (DE); Andreas Stuttgen, Alsdorf (DE); Andreas Wenning, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonil Degussa GmbH, Essen (DE)

(21) Appl. No.: 12/159,097

(22) PCT Filed: Nov. 3, 2006
(86) PCT No.: PCT/EP2006/068071

§ 371 Date: Jun. 25, 2008

(30) Foreign Application Priority Data
Jan. 3, 2006 (DE) 102006000645.3

(51) Int. Cl. C09D 11/10

(52) U.S. Cl. 523/160; 524/555; 524/543; 524/547; 524/94; 524/430; 524/421; 524/423; 524/436; 524/408; 524/407; 524/425; 524/424; 524/451; 524/444; 524/450; 524/449; 524/447; 524/433; 524/190; 524/90; 524/96; 524/88; 524/394; 524/392; 524/104; 524/294; 524/110; 524/441; 524/440; 523/171; 524/10; 523/161; 523/170

(57) ABSTRACT

The invention relates to new universal pigment preparations having very good thermal stability and weathering stability as virtually foam-free aqueous, solventborne, and solvent-free pigment preparations and to their use in aqueous, solventborne or solvent-free coating materials, such as paints, adhesives, inks, including printing inks, and for coloring plastics.

The invention relates to new universal pigment preparations having very good thermal stability and weathering stability as virtually foam-free aqueous, solventborne, and solvent-free pigment preparations and to their use in aqueous, solventborne or solvent-free coating materials, such as paints, adhesives, inks, including printing inks, and for coloring plastics.

Dispersing extenders and pigments in liquid media is generally accomplished using dispersants, in order thus to reduce the mechanical shearing forces required for effective dispersion of the solids and at the same time to realize very high filling levels. The dispersants assist with the disruption of agglomerates, act as surface-active compounds to wet and/or clad the surface of the particles to be dispersed, and stabilize these particles against unwanted reagglomeration.

In the production of inks and paints, wetting agents and dispersants facilitate the incorporation of pigments and extenders, which, as important formulating ingredients, substantially determine the visual appearance and the physicochemical properties of coatings. In order to allow their optimum utilization, these solids must on the one hand be dispersed uniformly in paints and inks, while on the other hand the state of dispersion, once attained, must be stabilized.

In many cases the stabilizing component function is also accomplished by binder components, which are used in coating materials particularly for the formation of a film. Binders of this kind are valuable components for coating materials on account additionally of their contribution to more rapid drying and to an increase in the hardness of the resultant films.

Important factors for application in universal pigment preparations include, first, universal compatibility with other binders—such as with the important long-oil alkyd resins, vegetable oils, hydrocarbon resins, acrylate resins, and polyamides, for example—and, secondly, universal solubility in organic solvents, such as in the white spirits and pure aliphatics which are frequently employed on environmental and toxicological grounds, for example. Binders of this kind which can be used in pigment preparations with universal compatibility and solubility in organic solvents are described in, for example, DE 44 04 809 and EP 1486520.

Furthermore, however, for universal application, the systems must be stably transferable to water.

Dispersants used for universal pigment preparations include, in particular, alkylphenol ethoxylates or fatty alcohol alkoxylates, which contribute to the steric stabilization of states of pigment dispersion that have been obtained, but which do not exhibit film-forming properties. The highly performing alkylphenol ethoxylates have come under criticism on ecotoxicological grounds. In many countries their use in detergents and cleaning products is already prohibited. Similar bans are likely for the paints and inks industries. Fatty alcohol ethoxylates fail in many cases to attain the same good pigment wetting properties as the alkylphenol ethoxylates, since they lack adsorptive groups. The unadsorbed portion of this product group, in particular, has the additional, unwanted effect of stabilizing the foam in aqueous pigment preparations.

Block-copolymeric polyalkylene oxides are toxicologically unobjectionable and highly adsorptive, while having less of a foam stabilization effect, but are likewise not film-formers. They are described in, for example, EP 1 078 946. However, these products are unable to achieve complete suppression of foam. Consequently, even here it is necessary to add actively defoaming substances to the aqueous pigment preparations. These substances, though, have other, adverse side-effects, such as unwanted surface defects. Many dispersing additives cannot be used on account of their adverse effect on the water resistance or light stability of coatings.

Compositions for producing universal pigment preparations are described in DE 10 2005 012 315.5, and their application in DE 10 2005 012 316.3. The ketone-aldehyde resins described therein are known. In pure form, ketone-aldehyde resins are used in coating materials as, for example, a film-forming addition component, in order to enhance certain properties such as initial drying rate, gloss, hardness or scratch resistance. On account of their relatively low molecular weight, typical ketone-aldehyde resins possess a low melt viscosity and solution viscosity.

As a result of irradiation, for example, the carbonyl groups of ketone-aldehyde resins undergo conventional degradation reactions such as those, for example, of Norrish type I or II [Laue, Plagens, Namen-und Schlagwort-Reaktionen, Teubner Studienbücher, Stuttgart, 1995]. It is therefore not possible to use ketone-aldehyde resins or ketone resins without modification for high-quality applications in the exterior segment, for example, where high resistance properties are called for, particularly in respect of weathering and heat. Moreover, the heat resistance of such resins is low.

These disadvantages can be remedied by hydrogenating the carbonyl groups. The conversion of the carbonyl groups into secondary alcohols by hydrogenation of ketone-aldehyde resins has been practiced for a long time (DE 826 974, DE 8 70 022, DE 32 41 735, JP 11012338, U.S. Pat. No. 6,222,009). The preparation of carbonyl-hydrogenated and ring-hydrogenated ketone-aldehyde resins based on ketones containing aromatic groups is likewise possible. Such resins are described in DE 33 34 631.

It was an object of the present invention, therefore, to find pigment preparations where there is broad compatibility with binders used and solubility in organic solvents used and water in conjunction with suppression of foam in aqueous pigment preparations. The pigment preparations ought additionally to be stable both to heat and to weathering.

The object on which the invention is based has surprisingly been achieved through the use of a combination of block-copolymeric, styrene oxide-containing polyalkylene oxides with carbonyl-hydrogenated ketone-aldehyde resins and/or ring-hydrogenated phenol-aldehyde resins and/or urea-aldehyde resins.

Surprisingly it has been found that the combination of block-copolymeric, styrene oxide-containing polyalkylene oxides and carbonyl-hydrogenated ketone-aldehyde resins and/or ring-hydrogenated phenol-aldehyde resins and/or urea-aldehyde resins is outstandingly suitable as a film-forming dispersant for not only solvent-free and solventborne but also aqueous universal pigment preparations.

A broad compatibility with binders, solubility in organic solvents used for universal pigment preparations, and miscibility and/or dispersibility in water have been found. Moreover, the formation of foam in aqueous pigment preparations is very efficiently suppressed. The properties of coating materials, such as initial drying and hardness, are positively influenced when they contain the pigment preparations of the invention. Furthermore, heat stabilities and weathering stabilities are high. Given knowledge of the prior art, it could not have been predicted that the combination of the individual components would lead to the composition possessing the stated sum of properties.

The invention provides aqueous, solventborne or solvent-free pigment preparations substantially containing
I. 2%-95% by weight of a composition substantially containing
A) 95% to 5% by weight of at least one block-copolymeric, styrene oxide-containing polyalkylene oxide,
and
B) 5% to 95% by weight of at least one carbonyl-hydrogenated ketone-aldehyde resin and/or ring-hydrogenated phenol-aldehyde resin and/or urea-aldehyde resin,
the sum of the amounts by weight of components I.A) and I.B) being 100% by weight,
and
II. 0 to 80% by weight of at least one solvent
and
III. 80%-5% by weight of at least one colorant,
and
IV. 0-20% by weight of auxiliaries and additives,
   the sum of the amounts by weight of components I. to IV. being 100% by weight and it being also possible for the amounts of components II. and IV. in the pigment preparation to be 0% by weight.

Since block-copolymeric, styrene oxide-containing polyalkylene oxides and also carbonyl-hydrogenated ketone-aldehyde resins, ring-hydrogenated phenol-aldehyde resins, and urea-aldehyde resins are all insoluble in water, it was completely surprising that a combination of the components is miscible and/or dispersible in water and allows use in aqueous pigment preparations.

### Component I.

The block-copolymeric, styrene oxide-containing polyalkylene oxides I.A) that are used with preference in the invention are described in, for example, EP 1 078 946. They possess the general formula (a):

R¹O(SO)ₐ(EO)_{b}(PO)_{c}(BO)_{d}R², (a)

where R¹ is a linear or branched or cycloaliphatic radical having 1 to 13 carbon atoms,
R² is hydrogen or an aryl, alkyl or carboxylic acid radical having in each case 1 to 8 carbon atoms,
SO=styrene oxide,
EO=ethylene oxide,
PO=propylene oxide,
BO=butylene oxide, and
a=1 to 10,
b=3 to 50,
c=0 to 3,
d=0 to 3,
a, c or d being other than 0, and b>=a+c+d.

In principle, however, all block-copolymeric, styrene oxide-containing polyalkylene oxides are suitable as component I.A).

Suitable ketones for preparing the carbonyl-hydrogenated ketone-aldehyde resins (component I.B) include all ketones, in particular acetone, acetophenone, methyl ethyl ketone, heptan-2-one, pentan-3-one, methyl isobutyl ketone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones having one or more alkyl radicals containing in total from 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

Generally speaking, however, it is possible to use all ketones said in the literature to be suitable for ketone resin syntheses, more generally all C—H-acidic ketones. Preference is given to carbonyl-hydrogenated ketone-aldehyde resins based on the ketones acetophenone, cyclohexanone, 4-tert-butylcyclohexanone, 3,3,5-trimethylcyclohexanone, methyl isobutyl ketone, and heptanone, alone or in a mixture.

Suitability as an aldehyde component of the carbonyl-hydrogenated ketone-aldehyde resins (component I.B) is possessed in principle by unbranched or branched aldehydes, such as formaldehyde, acetaldehyde, n-butyraldehyde and/or isobutyraldehyde, valeraldehyde, and dodecanal. In general it is possible to use all of the aldehydes said in the literature to be suitable for ketone resin syntheses. Preference is given, however, to using formaldehyde, alone or in mixtures.

The requisite formaldehyde is typically employed in the form of an aqueous or alcoholic (e.g., methanol or butanol) solution with a strength of from approximately 20% to 40% by weight. Other forms of formaldehyde as well, such as the use of para-formaldehyde or trioxane, for example, are likewise possible. Aromatic aldehydes, such as benzaldehyde, may likewise be present in a mixture with formaldehyde.

Particularly preferred carbonyl-hydrogenated resins used as starting compounds for component I.B) are those formed from acetophenone, cyclohexanone, 4-tert-butylcyclohexanone, 3,3,5-trimethylcyclohexanone, methyl isobutyl ketone, and heptanone, alone or in a mixture, and formaldehyde.

The resins formed from ketone and aldehyde are hydrogenated with hydrogen in the presence of a catalyst at pressures of up to 300 bar. In the course of this reaction the carbonyl group of the ketone-aldehyde resin is converted into a secondary hydroxyl group. Depending on reaction conditions, some of the hydroxyl groups may be eliminated, resulting in methylene groups. This is illustrated by the following scheme:

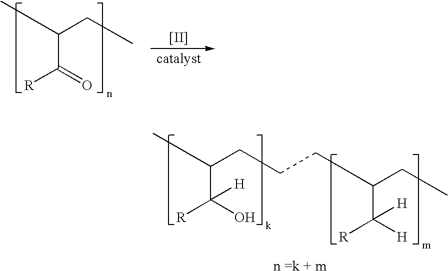

As component I.B) use is also made of ring-hydrogenated phenol-aldehyde resins of the novolak type, using, for example, the aldehydes formaldehyde, butyraldehyde or benzaldehyde, preferably formaldehyde. To a minor extent it is possible to use unhydrogenated novolaks, which then, however, possess lower lightfastnesses.

Particular suitability is possessed by ring-hydrogenated resins based on alkyl-substituted phenols. In general it is possible to use all of the phenols said in the literature to be suitable for phenolic resin syntheses.

Examples that may be mentioned of suitable phenols include phenol, 2- and 4-tert-butylphenol, 4-amylphenol, nonylphenol, 2- and 4-tert-octylphenol, dodecylphenol, cresol, xylenols, and bisphenols. They can be used alone or in a mixture.

Very particular preference is given to using ring-hydrogenated, alkyl-substituted phenol-formaldehyde resins of the novolak type. Preferred phenolic resins are reaction products of formaldehyde and 2- and 4-tert-butylphenol, 4-amylphenol, nonylphenol, 2- and 4-tert-octylphenol, and dodecylphenol.

The novolaks are hydrogenated with hydrogen in the presence of an appropriate catalyst. Through the choice of catalyst the aromatic ring is converted into a cycloaliphatic ring. Through an appropriate choice of parameters the hydroxyl group is retained.

This is illustrated by the following scheme:

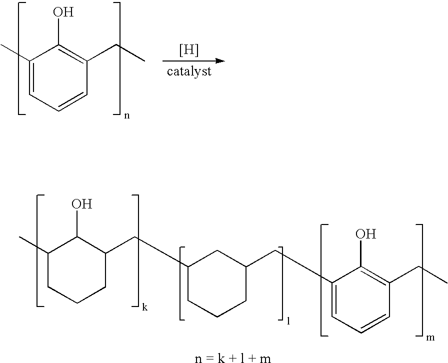

Through the choice of the hydrogenating conditions it is also possible to hydrogenate the hydroxyl groups, thereby forming cycloaliphatic rings. The ring-hydrogenated resins possess OH numbers of from 50 to 450 mg KOH/g, preferably from 100 to 350 mg KOH/g, more preferably from 150 to 300 mg KOH/g. The fraction of aromatic groups is below 50% by weight, preferably below 30% by weight, more preferably below 10% by weight.

The preparation and monomers for the urea-aldehyde resins (component I.B)) area described in EP 0 271 776:

As component I.B) use is made of urea-aldehyde resins using a urea of the general formula (i)

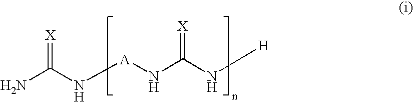

in which X is oxygen or sulfur, A is an alkylene radical, and n is from 0 to 3 with from 1.9 (n+1) to 2.2 (n+1) mol of an aldehyde of the general formula (ii)

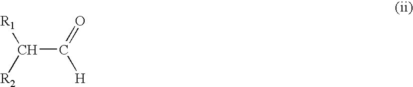

in which R₁ and R₂ are each hydrocarbon radicals (e.g., alkyl, aryl and/or alkylaryl radicals) having up to 20 carbon atoms
and/or formaldehyde.

Suitable ureas of the general formula (I) with n=0 are, for example, urea and thiourea, and with n=1 are methylenediurea, ethylenediurea, tetramethylenediurea and/or hexamethylene-diurea, and also mixtures thereof. Preference is given to urea.

Examples of suitable aldehydes of the general formula (II) include isobutyraldehyde, 2-methylpentanal, 2-ethylhexanal, 2-phenylpropanal, and mixtures thereof. Preference is given to isobutyraldehyde.

Formaldehyde may be used in aqueous form, which in part or in whole may also include alcohols such as methanol or ethanol, for example, as para-formaldehyde and/or trioxane.

Generally speaking, all monomers described in the literature for the preparation of aldehyde-urea resins are suitable. Typical compositions are described in, for example, DE 27 57 220, DE-A 27 57 176 and EP 0 271 776.

The mixing ratio of the block-copolymeric, styrene oxide-containing polyalkylene oxides and of the ketone-aldehyde resins used in accordance with the invention is from 95:5 to 5:95. If more than 50% by weight of component I.B) is used in this mixture then it is necessary to use a solvent II., for reasons of viscosity.

### Component II.

Suitable components II include water and all organic solvents. The organic solvents include for example alcohols, esters, ketones, ethers, glycol ethers, aromatic hydrocarbons, hydro-aromatic hydrocarbons, halogenated hydrocarbons, terpene hydrocarbons, aliphatic hydro-carbons, ester alcohols, dimethylformamide or dimethyl sulfoxide.

It is also possible to use what are known as reactive diluents, which are typically used in radiation-curable paints and inks.

Solvents which can be used with preference as reactive diluents are acrylic acid and/or methacrylic acid, C₁-C₄₀ alkyl esters and/or cycloalkyl esters of methacrylic acid and/or acrylic acid, glycidyl methacrylate, glycidyl acrylate, 1,2-epoxybutyl acrylate, 1,2-epoxybutyl methacrylate, 2,3-epoxycyclopentyl acrylate, 2,3-epoxycyclopentyl methacrylate, and the analogous amides, it also being possible for styrene and/or derivatives thereof to be present.

A further preferred class of radiation-reactive solvents as reactive diluents are di-, tri- and/or tetraacrylates and their methacrylic analogs that result formally from the reaction products of acrylic acid and/or methacrylic acid with an alcohol component, with elimination of water. As an alcohol component customary for this purpose, use is made for example of ethylene glycol, 1,2-, 1,3-propanediol, diethylene glycol, di- and tripropylene glycol, triethylene glycol, tetraethylene glycol, 1,2-, 1,4-butanediol, 1,3-butylethylpropanediol, 1,3-methylpropanediol, 1,5-pentanediol, 1,4-bis(hydroxymethyl)(cyclohexanedimethanol), glycerol, hexanediol, neo-pentyl glycol, trimethylolethane, trimethylolpropane, pentaerythritol, bisphenol A, B, C, F, norbornylene glycol, 1,4-benzyldimethanol, 1,4-benzyldiethanol, 2,4-dimethyl-2-ethylhexane-1,3-diol, butylene 1,4- and 2,3-glycol, di-β-hydroxyethylbutanediol, 1,5-pentanediol, 1,6-hexanediol, 1,8-octanediol, decanediol, dodecanediol, neopentyl glycol, cyclohexanediol, trimethylolpropane, 3(4),8(9)-bis(hydroxymethyl)tricyclo[5.2.1.0^{2,6}]decane (Dicidol), 2,2-bis-(4-hydroxycyclohexyl)propane, 2,2-bis[4-(β-hydroxyethoxy)phenyl]propane, 2-methylpro-pane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl)isocyanurate, mannitol, sorbitol, polypropylene glycols, polybutylene glycols, xylylene glycol or neopentyl glycol hydroxypivalate, and also ethylene- or propylene-containing derivatives thereof, alone or in mixtures.

It is also possible to use ionic liquids as solvents. Ionic liquids for the purposes of the present invention are salts which have a melting point of not more than 100° C. ILs are reviewed by, for example, Welton (Chem. Rev. 99 (1999), 2071) and Wasserscheid et al. (Angew. Chem. 112 (2000), 3926).

For solventborne pigment preparations preference is given to organic solvents which are environmentally and toxicologically unobjectionable. For aqueous pigment preparations preference is given to organic solvents which are compatible or miscible, at least to a certain degree, with water, and/or to ionic liquids. Suitability for radiation-curable pigment preparations is possessed by reactive solvents (reactive diluents) which are able to polymerize under induction by radiation.

For aqueous pigment preparations, however, the mixture of block-copolymeric, styrene-oxide-containing polyalkylene oxides I.A) and carbonyl-hydrogenated ketone-aldehyde resins and/or ring-hydrogenated phenol-aldehyde resins and/or urea-aldehyde resins I.B) is preferably chosen so that there is no need to include an organic solvent as component II.

### Component III.

Colorants which can be used (component III.) include, for example, organic or inorganic pigments, extenders, carbon blacks, and dyes.

Inorganic pigments and extenders are used, such as Milori blue, titanium dioxide, iron oxides, metal pigments (e.g., spinel, bismuth vanadate, nickel titanium, chromium oxide), pigmentary carbon blacks, and also carbonates, such as chalk, fine limestone powder, calcite, dolomite, and barium carbonate, sulfates, such as barytes, blanc fixe, and calcium sulfates, silicates, such as talc, pyrophyllite, chlorite, mica, kaolin, slate flour, feldspars, precipitated Ca, Al, Ca/Al, and Na/Al silicates, silicas, such as quartz, fused silica, crystoballite, kieselguhr, precipitated and/or pyrogenic silicas, fine glass powder, and oxides, such as magnesium oxides and hydroxides and aluminum oxides and hydroxides, fibrous fillers, and organic pigments, such as isoindoline, azo, quinacridone, perylene, dioxazine, metal complex pigments such as phthalocyanines, anthraquinonoid pigments, polycyclic pigments, particularly those of the thioindigo, quinacridone, dioxazine, pyrrolo, naphthalenetetra-carboxylic acid, perylene, isoamidolin(on)e, flavanthrone, pyranthrone or isoviolanthrone series. It is further possible to use metallic effect pigments such as aluminum, copper, copper/zinc, and zinc pigments, oxidized bronzes, iron oxide-aluminum pigments, interference pigments and pearlescent pigments such as metal oxide-mica pigments, bismuth oxychloride, basic lead carbonate, pearl essence or micronized titanium dioxide, graphite in leaflet form, iron oxide in leaflet form, multilayer effect pigments from PVD films or produced by the CVD (chemical vapor deposition) method, and liquid-crystal (polymer) pigments.

As carbon blacks it is possible to use gas blacks, lamp blacks or furnace blacks. These carbon blacks may additionally have been reoxidized and/or beaded.

Dyes are employed in addition. As dyes which are soluble in the binder solutions used it is possible to employ all natural or synthetic organic dyes. The colorations obtained therewith possess optimum transparency but not opacity. In contrast to pigments it is possible to utilize their color strength to the full.

Natural dyes are animal dyes, such as carmine, kermes, lac dyes, Indian yellow, purple, sepia or gallstone, and vegetable dyes, such as indigo, alizarin dyes, flavonol dyes, dyes of the brasilin group, or color resins such as dragon's blood or gamboge, for example.

Examples of synthetic dyes include basic dyes and color bases, acidic dyes and water-soluble metal complex dyes, alcohol- and ester-soluble dyes, and oil- and fat-soluble dyes.

A compilation of pigments, dyes, and extenders used is given in Römpp Lexikon, Lacke und Druckfarben, edited by Dr. Ulrich Zorll, Georg Thieme Verlag, Stuttgart, 1998 or in Pigment-und Füllstofftabellen, edited by Olaf Lückert, Vincentz Verlag, Hanover 2002.

### Component IV.

Suitable components IV. are auxiliaries and additives such as, for example, inhibitors, surface-active substances, oxygen scavengers, free-radical scavengers, catalysts, light stabilizers, color brighteners, photosensitizers, photoinitiators, additives for influencing rheological properties, such as thixotropic agents and/or thickeners, flow control agents, anti-skinning agents, defoamers, devolatilizers, antistats, antiblocking agents, lubricants, further wetting agents and dispersants, preservatives, including for example fungicides and/or biocides, further oligomers and/or polymers, such as polyesters, polyacrylates, polyethers, and epoxy resins, thermoplastic additives, plasticizers, matting agents flame retardants, internal release agent and/or blowing agents.

The invention also provides a process for preparing aqueous, solventborne or solvent-free pigment preparations substantially containing

I. 2%-95% by weight of a composition substantially containing
A) 95% to 5% by weight of at least one block-copolymeric, styrene oxide-containing polyalkylene oxide,
and
B) 5% to 95% by weight of at least one carbonyl-hydrogenated ketone-aldehyde resin and/or ring-hydrogenated phenol-aldehyde resin and/or urea-aldehyde resin,
the sum of the amounts by weight of components I.A) and I.B) being 100% by weight,
   and
   II. 0 to 80% by weight of at least one solvent
   and
   III. 80%-5% by weight of at least one colorant,
   and
   IV. 0-20% by weight of auxiliaries and additives,
   the sum of the amounts by weight of components I. to IV. being 100% by weight and it being also possible for the amounts of components II. and IV. in the pigment preparation to be 0% by weight, by mixing and dispersing compounds I., II., III., and IV. at a temperature from 20 to 150° C. in a Dispermat, Skandex mixer, Red Devil, single-roll mill, triple-roll mill, bead mill or other suitable assembly.

The mixture of component I., when used in accordance with the invention, may either be mixed beforehand with the pigments that are to be dispersed, or dissolved directly in the aqueous or solventborne dispersion medium, prior to or simultaneously with the addition of the pigments.

The pigment preparations of the invention can be used in particular for solventborne and aqueous coating materials and for solvent-free coating materials (radiation-curable coating materials and/or powder coating materials, for example), such as filling compounds, surfacers, basecoat and/or topcoat materials, and also printing inks, ballpoint pen pastes, pigment pastes, graphics inks, polishes, glazes, lamination systems, cosmectics articles, sealants and/or insulants, and also for adhesives, and for coloring plastics.

The substrates coated may comprise, for example, metals, plastics, paper, cardboard, inorganic materials such as ceramic, stone, concrete and/or glass, textiles, fibers, woven materials, leather and/or synthetic materials, such as synthetic leathers, wood, sheets of plastics and/or composites, such as aluminum-clad films. The pigment preparations can be used for all conceivable applications both in the interior and in the exterior segments, such as, for example, architectural preservation, automobiles, coil coating, can coating, textile finishing, wood varnishes, decorative applications, etc. Compositions of this kind are suitable additionally for use in adhesives, such as for the bonding of textiles, leather, paper, and similar materials, for example, and for coloring plastics.

The invention accordingly also provides for the use of aqueous, solventborne or solvent-free pigment preparations substantially containing

I. 2%-95% by weight of a composition substantially containing
A) 95% to 5% by weight of at least one block-copolymeric, styrene oxide-containing polyalkylene oxide,
   and
B) 5% to 95% by weight of at least one carbonyl-hydrogenated ketone-aldehyde resin and/or ring-hydrogenated phenol-aldehyde resin and/or urea-aldehyde resin,
the sum of the amounts by weight of components I.A) and I.B) being 100% by weight,
   and
   II. 0 to 80% by weight of at least one solvent
   and
   III. 80%-5% by weight of at least one colorant,
   and
   IV. 0-20% by weight of auxiliaries and additives,
   the sum of the amounts by weight of components I. to IV. being 100% by weight and it being also possible for the amounts of components II. and IV. in the pigment preparation to be 0% by weight, in coating materials, such as filling compounds, surfacers, basecoat and/or topcoat materials, and also printing inks, ballpoint pen pastes, pigment pastes, graphics inks, polishes, glazes, lamination systems, cosmetics articles, sealants and/or insulants, and also adhesives, and for coloring plastics.

As coating materials into which the pigment preparations of the invention can be introduced with preference suitability is possessed by all aqueous, solventborne and solvent-free systems that are known to the skilled worker. These systems may, for example, be physically drying, oxidatively drying, or otherwise reactive 1-component or 2-component surface-coating materials.

Through the use of component I., essential to the invention, pigment preparations are obtained which are distinguished by very good adsorptivity to pigments, excellent foam destruction, and a low viscosity. Moreover, the drying rate, water resistance, chemical resistance, and hardness of the coatings are positively influenced. The heat stability and weathering stability are very good.

The examples which follow are intended to illustrate the invention but not to restrict the scope of its application.

### EXAMPLES

### 1) Preparation of a Styrene Oxide-Containing Polyalkylene Oxide (Component I.A))

336.4 g (2.34 mol) of trimethylcyclohexanol and 16.3 g (0.23 mol) of potassium methoxide were charged to a reactor. After careful flushing with pure nitrogen, the initial charge was heated to 110° C., and 308.2 g (2.554 mol) of styrene oxide were added over the course of an hour. After a further two hours the addition reaction of the styrene oxide was at an end, as evidenced by a residual styrene oxide content of <0.1% by weight according to gas chromatogram. Subsequently 339.2 g (7.71 mol) of ethylene oxide were metered into the reactor at a rate such that the internal temperature did not exceed 120° C. and the pressure did not exceed 6 bar. Following complete introduction of the ethylene oxide, the temperature was held at 115° C. until a constant manometer pressure indicated the end of the subsequent reaction. Lastly, at 80 to 90° C., the unreacted, residual monomers were removed under reduced pressure. The product obtained was neutralized with the aid of phosphoric acid, followed by removal of the water by distillation and of the potassium phosphate by filtration together with a filter aid. The molecular weight from the determination of the hydroxyl number, with an assumed functionality of 1, was M=467 g/mol.

### 2) Preparation of a Carbonyl-Hydrogenated Ketone-Aldehyde Resin (Component I.B))

1200 g of acetophenone, 220 g of methanol, 0.3 g of benzyltributylammonium chloride, and 360 g of a 30% strength aqueous formaldehyde solution are introduced as an initial charge and homogenized with stirring. Then 32 g of 25% strength aqueous sodium hydroxide solution are added with stirring. This is followed at 80 to 85° C. by the addition with stirring of 655 g of 30% strength aqueous formaldehyde solution over 90 minutes. After 5 hours of stirring at reflux temperature the stirrer is switched off and the aqueous phase is separated from the resin phase. The crude product is washed with water, to which acetic acid has been added, until a melt sample of the resin appears clear. At that point the resin is dried by distillation. This gives 1270 g of a pale yellowish resin. The resin is clear and brittle and possesses a melting point of 72° C. It is soluble in, for example, acetates such as butyl acetate and ethyl acetate, and in aromatics such as toluene and xylene. It is insoluble in ethanol.

400 g of the resin thus prepared are dissolved in 650 g of tetrahydrofuran (water content approximately 7%). This is followed by hydrogenation at 260 bar and 160° C. in an autoclave (Parr) with a catalyst basket filled with 100 ml of a commercially customary Ru catalyst (3% Ru on alumina). After 20 hours the reaction mixture is discharged from the reactor via a filter. Properties: hydroxyl number 315 mg KOH/g; melting point 116° C.; Gardner color number (50% in ethyl acetate) 0.2.

The hydrogenated resin is soluble in ethanol, dichloromethane, ethyl acetate, butyl acetate, isopropanol, acetone, and diethyl ether. It is insoluble in non-polar solvents such as n-hexane or white spirit.

### 3) Preparation of Inventive Composition I

600 g of the styrene oxide-containing polyalkylene oxide from Example 1) and 400 g of the carbonyl-hydrogenating ketone-aldehyde resin from Example 2) were mixed with one another and homogenized at 100° C. with stirring. The product was clear and of high viscosity and was soluble in water, ethanol, ethyl acetate, butyl acetate, and xylene.

The following procedure was adopted to investigate the activity of the inventive composition as a dispersing additive having binder properties, and also of the comparison compounds:

### 4) Production of the Pigment Preparations

For this purpose the inventive composition according to Example 3) was mixed with water and/or organic solvent, after which the pigments were added. Dispersing took place following the addition of 2 mm glass beads in a Dispermat at 3000 rpm and 35° C. for 30 minutes. The aqueous pigment preparations were adjusted with a mixture of dimethylaminoethanol and water (1:1% by weight) to a pH of approximately 9.

### 4A) Formulation of an Aqueous Black Pigment Preparation (Inventive)

63 g water
8 g inventive composition from Example 3)
20 g Spezialschwarz 4 carbon black (Degussa AG)

This black pigment preparation was readily stirrable and foam-free.

### 4B) Formulation of an Aqueous Black Pigment Preparation (Comparative)

71 g water
8 g noninventive compound from Example 1)
20 g Spezialschwarz 4 carbon black (Degussa AG)

This black pigment preparation was highly viscous and exhibited severe foaming.

### 4C) Formulation of a Solventborne Black Pigment Preparation (Inventive)

75 g butyl glycol
25 g inventive composition from Example 3)
20 g Spezialschwarz 4 carbon black (Degussa AG)

This black pigment preparation was of low viscosity.

### 4D) Formulation of an Aqueous Blue Pigment Preparation (Inventive)

80.0 g water
20.0 g inventive composition from Example 3)
48.0 g Heliogenblau L 6975F blue pigment (BASF AG)

This blue pigment preparation was of low viscosity, readily stirrable, and foam-free. It was also of unchanged stability after storage at 50° C. for more than one week.

### 4E) Formulation of an Aqueous Blue Pigment Preparation (Comparative)

80.0 g water
20.0 g noninventive compound from Example 1)
48.0 g Heliogenblau L 6975F blue pigment (BASF AG)

This blue pigment preparation was highly viscous and exhibited severe foaming.

### 5) Preparation of Coating Materials from the Pigment Preparations

Coating materials were prepared by introducing the letdown compounds and adding the pigment preparations in portions.

### 5A) Preparation of Solvent-Free Black Coating Materials

The inventive (Example 4A) and noninventive (Example 4B) pigment preparations were let down with an aqueous polyurethane dispersion.

| | Inventive | |
|---|---|---|
| | 8.4 g from | Comparative |
| Black pigment preparation | Example 4A) | 8.4 g from Example 4B) |
| Alberdingk U 800 | 63.0 g | 63.0 g |
| (Alberdingk Boley GmbH) | | |

Drying: 1 h at 60° C., drawdown onto glass plate with 100 μm frame

| | | |
|---|---|---|
| Gloss 20° | 75 | 74 |
| Gloss 60° | 88 | 84 |
| Haze gloss | 17 | 22 |
| Pendulum hardness | 94 | 87 |

### 5B) Preparative of Solventborne and Low-Solvent Black Coating Materials

The inventive solventborne black pigment preparation (Example 4C) was let down both as a solventborne system and as an aqueous system.

| | | 7.0 g from |
|---|---|---|
| Black pigment preparation | 6.8 g from Example 4C) | Example 4C) |
| Degalan 706 (Röhm GmbH) | 50.0 g | 63.0 g |
| Dynapol HW 112-56 | — | 55.5 g |
| (Degussa AG) | | |
| Cymel 325 (Cytec) | — | 3.7 g |
| Demineralized water | — | 10.0 g |
| Tego 7447, 10% in water | — | 0.8 g |
| (Tego Chemie Service | | |
| GmbH) | | |

| Drawdown onto glass plate | | Drying: 20 |
|---|---|---|
| with 100 μm frame | Drying: 24 h at 25° C. | minutes at 140° C. |
| Gloss 20° | 76 | 95 |
| Gloss 60° | 89 | 99 |
| Haze gloss | 19-28 | 67-74 |
| Pendulum hardness | 148 | 186 |

### 6) Preparation of Tinted Paints

Tinted varnishes were prepared by mixing the blue-pigmented pigment preparations of Examples 4D) and 4E) with a white paint.

The white paint consisted of 70.69 g of Alberdingk U 800 (Alberdingk Boley GmbH), 28.24 g of Kronos 2310 (Kronos Titan GmbH), and 0.07 g of Aerosil 200 (Degussa AG).

| | Inventive | Comparative |
|---|---|---|
| White paint | 99.0 g | 99.0 g |
| Blue pigment | 3.7 g from Example 4D) | 3.7 g from Example 4E) |
| preparation | | |
| Demineralized water | 6.5 g | 6.5 g |

The binder/white pigment ratio was 1:1 and the ratio of blue pigment to white paint 1:100.

The tinted paints drawn down using a 100 μm drawing frame were dried for 2 minutes and then subjected to rub-out testing. Additionally the relative color strength was measured.

| | Color strength F | Δ E after rub-out |
|---|---|---|
| Inventive | 100% | 0.29 |
| Comparative | 94% | 0.45 |

The tinted paint based on the inventive composition dried substantially more quickly than the comparative tinted paint.

The films were stored in an oven at 60° C. for 14 days. No yellowing was observed.

In addition the coatings were stored over 1000 h in a Weather-Ometer.

| | Relative gloss | |
|---|---|---|
| | reduction¹⁾ | Relative b* value²⁾ |
| Inventive | 0.75 | 1.4 |
| Comparative | 0.70 | 1.4 |

¹⁾Gloss after/gloss before weathering
²⁾b* after/b* before weathering

The compositions of the invention possess good heat stability and weathering stability.

With the pigment preparations of the invention it is possible to produce solventborne, low-solvent, and solvent-free coating materials. In contrast to the comparative examples, the aqueous pigment preparations are of low viscosity and are virtually foam-free.

Furthermore, the development of color strength and the flocculation resistance of pigment preparations, and also the initial drying of coatings, were positively influenced.

1. An aqueous, solventborne or solvent-free pigment preparation substantially containing
1.2%-95% by weight of a composition substantially containing
A) 95% to 5% by weight of at least one block-copolymeric, styrene oxide-containing polyalkylene oxide,
and
B) 5% to 95% by weight of at least one carbonyl-hydrogenated ketone-aldehyde resin and/or ring-hydrogenated phenol-aldehyde resin and/or urea-aldehyde resin, the sum of the amounts by weight of components I.A) and I.B) being 100% by weight, and
II. 0 to 80% by weight of at least one solvent
and
III. 80%-5% by weight of at least one colorant,
and
IV. 0-20% by weight of auxiliaries and additives,
the sum of the amounts by weight of components I. to IV. being 100% by weight and it being also possible for the amounts of components II. and IV. in the pigment preparation to be 0% by weight.

2. A pigment preparation according to claim 1,
characterized in that
the block-copolymeric, styrene oxide-containing polyalkylene oxide I.A) possesses the general formula I:
R¹O(SO)ₐ(EO)_{b}(PO)_{c}(BO)_{d}R²,
where R¹ is a linear or branched or cycloaliphatic radical having 1 to 13 carbon atoms, R² is hydrogen or an aryl, alkyl or carboxylic acid radical having in each case 1 to 8 carbon atoms,
SO=styrene oxide,
EO=ethylene oxide,
PO=propylene oxide,
BO=butylene oxide, and
a=1 to 10,
b=3 to 50,
c=0 to 3,
d=0 to 3,
a, c or d being other than 0, and b>=a+c+d.

3. A pigment preparation according to claim 1, characterized in that C—H acidic ketone is used for preparing the carbonyl-hydrogenated ketone-aldehyde resin I.B).

4. A pigment preparation according to claim 1, characterized in that
ketone selected from acetone, acetophenone, methyl ethyl ketone, heptan-2-one, pentan-3-one, methyl isobutyl ketone, cyclopentanone, cyclododecanone, a mixture of 2,2,4- and 2,4,4-trimethylcyclopentanone, cycloheptanone, cyclooctanone, and cyclohexanone as starting compounds, alone or in a mixture, is used for preparing the carbonyl-hydrogenated ketone-aldehyde resin I.B).

5. A pigment preparation according to claim 1, characterized in that
alkyl-substituted cyclohexanone having one or more alkyl radicals containing in total from 1 to 8 carbon atoms is used, individually or in a mixture, for preparing the carbonyl-hydrogenated ketone-aldehyde resin I.B).

6. A pigment preparation according to claim 1, characterized in that
tert-butylcyclohexanone, 2-methylcyclohexanone, and 3,3,5-trimethylcyclohexanone are used for preparing the carbonyl-hydrogenated ketone-aldehyde resin I.B).

7. A pigment preparation according to claim 1, characterized in that
cyclohexanone, 4-tert-butylcyclohexanone, 3,3,5-trimethylcyclohexanone, methyl isobutyl ketone or heptanone, alone or in a mixture, are used in component A) for preparing the carbonyl-hydrogenated ketone-aldehyde resin I.B).

8. A pigment preparation according to claim 1, characterized in that
formaldehyde, acetaldehyde, n-butyraldehyde and/or isobutyraldehyde, valeraldehyde or dodecanal, alone or in a mixture, is used as aldehyde component for preparing the carbonyl-hydrogenated ketone-aldehyde resin I.B).

9. A pigment preparation according to claim 1, characterized in that
formaldehyde and/or para-formaldehyde and/or trioxane are used for preparing the carbonyl-hydrogenated ketone-aldehyde resin I.B).

10. A pigment preparation according to claim 1, characterized in that
hydrogenation product of a resin formed from acetophenone, cyclohexanone, 4-tert-butylcyclohexanone, 3,3,5-trimethylcyclohexanone, methyl isobutyl ketone or heptanone, alone or in a mixture, and formaldehyde is used as carbonyl-hydrogenated ketone-aldehyde resin I.B).

11. A pigment preparation according to claim 1, characterized in that
formaldehyde, butyraldehyde and/or benzaldehyde are used as aldehyde for preparing the ring-hydrogenated phenol-aldehyde resin I.B).

12. A pigment preparation according to claim 1, characterized in that
alkyl-substituted phenol is used for preparing the ring-hydrogenated phenol-aldehyde resin I.B).

13. A pigment preparation according to claim 1, characterized in that
4-tert-butylphenol, 4-amylphenol, nonylphenol, tert-octylphenol, dodecylphenol, cresol, a xylenol or a bisphenol, alone or in a mixture, is used for preparing the ring-hydrogenated phenol-aldehyde resin I.B).

14. A pigment preparation according to claim 1, characterized in that
urea-aldehyde resin prepared using a urea of the general formula (i) 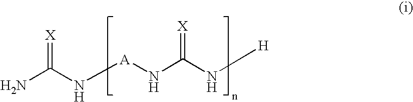
in which X is oxygen or sulfur, A is an alkylene radical, and n is 0 to 3 with from 1.9 (n+1) to 2.2 (n+1) mol of an aldehyde of the general formula (ii) 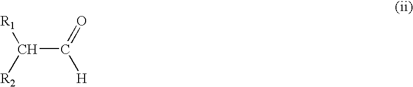
in which R₁ and R₂ are each hydrocarbon radicals having up to 20 carbon atoms and/or formaldehyde is used as component I.B).

15. A pigment preparation according to claim 1, characterized in that
urea-aldehyde resin prepared using urea and thiourea, methylenediurea, ethylenediurea, tetramethylenediurea and/or hexamethylenediurea or a mixture thereof is used as component I.B).

16. A pigment preparation according to claim 1, characterized in that
urea-aldehyde resin prepared using isobutyraldehyde, formaldehyde, 2-methylpentanal, 2-ethylhexanal or 2-phenylpropanal or a mixture thereof is used as component I.B).

17. A pigment preparation according to claim 1, characterized in that
urea-aldehyde resin prepared using urea, isobutyraldehyde, and formaldehyde is used as component I.B).

18. A pigment preparation according to claim 1, characterized in that
the mixing ratio of components I.A) and I.B) is from 95:5 to 5:95.

19. A pigment preparation according to claim 1, characterized in that
water is used as solvent II.

20. A pigment preparation according to claim 1, characterized in that
an organic solvent is present as solvent II.

21. A pigment preparation according to claim 1, characterized in that
at least one alcohol, ester, ketone, ether, glycol ether, aromatic hydrocarbon, hydroaromatic hydrocarbon, halogenated hydrocarbon, terpene hydrocarbon, aliphatic hydrocarbon, ester alcohol, dimethylformamide, dimethyl sulfoxide or a radiation-curable reactive diluent or an ionic liquid, alone or in a mixture, is present as solvent II.

22. A pigment preparation according to claim 1, characterized in that
colorant is present as component III.

23. A pigment preparation according to claim 1, characterized in that
colorant selected from pigments, dyes and/or extenders is present as component III.

24. A pigment preparation according to claim 1, characterized in that
organic and/or inorganic pigments and/or dyes and/or extenders and/or carbon blacks are present as colorants.

25. A pigment preparation according to claim 1, characterized in that
organic and/or inorganic pigments and/or dyes and/or extenders and/or carbon blacks are present as colorants, selected from
Milori blue, titanium dioxide, iron oxides, metal pigments (e.g., spinel, bismuth vanadate, nickel titanium, chromium oxide), pigmentary carbon blacks, such as gas blacks, lamp blacks or furnace blacks, which may additionally have been reoxidized and/or beaded, and also carbonates, such as chalk, fine limestone powder, calcite, dolomite, and barium carbonate, sulfates, such as barytes, blanc fixe, and calcium sulfates, silicates, such as talc, pyrophyllite, chlorite, mica, kaolin, slate flour, feldspars, precipitated Ca, Al, Ca/Al, and Na/Al silicates, silicas, such as quartz, fused silica, crystoballite, kieselguhr, precipitated and/or pyrogenic silicas, fine glass powder, and oxides, such as magnesium oxides and hydroxides and aluminum oxides and hydroxides, fibrous fillers, and organic pigments, such as isoindoline, azo, quinacridone, perylene, dioxazine, metal complex pigments such as phthalocyanines, anthraquinonoid pigments, polycyclic pigments, particularly those of the thioindigo, quinacridone, dioxazine, pyrrolo, naphthalenetetracarboxylic acid, perylene, isoamidolin(on)e, flavanthrone, pyranthrone or isoviolanthrone series, metallic effect pigments such as aluminum, copper, copper/zinc, and zinc pigments, oxidized bronzes, iron oxide-aluminum pigments, interference pigments and pearlescent pigments such as metal oxide-mica pigments, bismuth oxychloride, basic lead carbonate, pearl essence or micronized titanium dioxide, graphite in leaflet form, iron oxide in leaflet form, multilayer effect pigments from PVD films or produced by the CVD (chemical vapor deposition) method, liquid-crystal (polymer) pigments, natural dyes such as carmine, kermes, lac dyes, Indian yellow, purple, sepia or gallstone, and vegetable dyes, such as indigo, alizarin dyes, flavonol dyes, dyes of the brasilin group, or color resins such as dragon's blood or gamboge; synthetic dyes such as basic dyes and color bases, acidic dyes, and water-soluble metal complex dyes, alcohol- and ester-soluble dyes, and oil- and fat-soluble dyes, alone or in a mixture.

26. A pigment preparation according to claim 1, characterized in that
auxiliaries and additives are present as component IV.

27. A pigment preparation according to claim 1, characterized in that
auxiliaries and additives are present as component IV., selected from inhibitors, surface-active substances, oxygen scavengers, free-radical scavengers, catalysts, light stabilizers, color brighteners, photosensitizers, photoinitiators, additives for influencing rheological properties, such as thixotropic agents and/or thickeners, flow control agents, anti-skinning agents, defoamers, devolatilizers, antistats, antiblocking agents, lubricants, further wetting agents and dispersants, preservatives, including for example fungicides and/or biocides, further oligomers and/or polymers, such as polyesters, polyacrylates, polyethers, and epoxy resins, thermoplastic additives, plasticizers, matting agents, flame retardants, internal release agents and/or blowing agents.

28. A process for preparing an aqueous, solventborne or solvent-free pigment preparation according to claim 1 and substantially containing
1.2%-95% by weight of a composition substantially containing
A) 95% to 5% by weight of at least one block-copolymeric, styrene oxide-containing polyalkylene oxide,
and
B) 5% to 95% by weight of at least one carbonyl-hydrogenated ketone-aldehyde resin and/or ring-hydrogenated phenol-aldehyde resin and/or urea-aldehyde resin, the sum of the amounts by weight of components I.A) and I.B) being 100% by weight,
and
II. 0 to 80% by weight of at least one solvent
and
III. 80%-5% by weight of at least one colorant,
and
IV. 0-20% by weight of auxiliaries and additives,
the sum of the amounts by weight of components I. to IV. being 100% by weight and it being also possible for the amounts of components II. and IV. in the pigment preparation to be 0% by weight,
by mixing and dispersing compounds I., II., III., and IV. at a temperature from 20 to 150° C. in a Dispermat, Skandex mixer, Red Devil, single-roll mill, triple-roll mill, bead mill or other suitable assembly.

29. The method of using an aqueous, solventborne or solvent-free pigment preparation according to claim 1 and substantially containing
I. 2%-95% by weight of a composition substantially containing
A) 95% to 5% by weight of at least one block-copolymeric, styrene oxide-containing polyalkylene oxide,
and
B) 5% to 95% by weight of at least one carbonyl-hydrogenated ketone-aldehyde resin and/or ring-hydrogenated phenol-aldehyde resin and/or urea-aldehyde resin, the sum of the amounts by weight of components I.A) and I.B) being 100% by weight,
and
II. 0 to 80% by weight of at least one solvent
and
III. 80%-5% by weight of at least one colorant,
and
IV. 0-20% by weight of auxiliaries and additives,
the sum of the amounts by weight of components I. to IV. being 100% by weight and it being also possible for the amounts of components II. and IV. in the pigment preparation to be 0% by weight, in coating materials or adhesives.

30. The method of using an aqueous, solventborne or solvent-free pigment preparation according to claim 29 in coating materials, such as filling compounds, surfacers, basecoat and/or topcoat materials, or printing inks, ballpoint pen pastes, pigment pastes, graphics inks, polishes, glazes, lamination systems, cosmetics articles, sealants, insulants or adhesives.

31. The method of using an aqueous, solventborne or solvent-free pigment preparation according to claim 29 for coating and/or printing and/or laminating and/or bonding an article.

32. The method of using an aqueous, solventborne or solvent-free pigment preparation according to claim 29 for coating or printing or laminating or bonding an article made of metals, plastics, paper, cardboard, inorganic materials ceramic, stone, concrete or glass, textiles, fibers, woven materials, leather or synthetic materials, synthetic leathers, wood, sheets of plastics or composites aluminum-clad films.

33. An article produced or coated using an aqueous, solventborne or solvent-free pigment preparation according to claim 29.
